(19) United States
(12) Patent Application Publication
(10) Pub. No.: US 2003/0094778 A1
(43) Pub. Date: May 22, 2003

(54) Transport trolley, especially for the transporting of piece goods

(76) Inventor: Adrian Hungerbuhler, Dozwil (CH)

Correspondence Address: LADAS & PARRY, 224 SOUTH MICHIGAN AVENUE, SUITE 1200, CHICAGO, IL, 60604, US

(21) Appl. No.: 10/287,378

(22) Filed: Nov. 4, 2002

(30) Foreign Application Priority Data
Nov. 16, 2001 (DE) 101 56 367.1

(51) Int. Cl. B62B 1/00

(52) U.S. Cl. 280/47.131

(57) ABSTRACT

Transport trolley (100), especially for the transporting of piece goods, having a carrier (10), which forms a housing for said piece goods, affixed to a navigable frame (20) and pivotable from a loading state, in which said carrier (10) is arranged with a horizontal alignment, into a transporting state in which said carrier (10) is arranged to be tilted out of the horizontal, wherein said frame (20) is provided with a stand wheel cantilever (30) which juts out from said frame (20) in the transport trolley loading state and forms a support, and which rests against frame (20) in the transport trolley transporting state.

The present invention relates to a transport trolley, especially for transporting piece goods or objects such as, for example, a transport trolley to be used when shopping for merchandise.

When buying merchandise in a supermarket, customers place items from the shelves into a shopping cart and then from there onto a cash register's conveyor belt. After paying, the goods are repacked back into the shopping cart or into a bag and then possibly from there into the trunk of a vehicle, a towing receptacle on a bicycle, or a personal shopping trolley. This is a time-consuming and cumbersome procedure. The frequent reloading can also have an adverse affect on the items purchased, particularly goods which are breakable or fragile. Special disadvantages arise with respect to food shopping. Perishable, soft or liquid goods may be damaged from repeated reloading. Frozen products may thaw or defrost prematurely.

Known shopping trolleys for personal use consist essentially of a large, sturdy bag fastened onto a frame having two wheels and a handle. These so-called pull-carts or caddies can stand alone when the bag is vertically aligned or, in tilted state, can be pulled by a person as a handcart. The conventional pull-carts may certainly make travelling home after making purchases easier, yet they still do not solve the problems mentioned above since repacking is still required in the supermarket. In addition, loading the bag is an arduous process since it is positioned low to facilitate pulling and requires a stooping motion when filling it.

The cited problems in transporting objects are not exclusive to shopping. For example, craftsmen who work at several different locations during the course of a day also have a need to effectively and carefully transport tools and materials, for example from a warehouse to a vehicle and then to a customer. Corresponding transporting tasks furthermore exist in the operation of portable equipment, for example when taking mobile measurements, etc., in which it is important to be able to readily maneuver a transport trolley smoothly and unproblematically under the most varied of conditions.

It is the object of the present invention to provide an improved transport trolley, particularly for the transporting of piece goods, which surmounts the disadvantages of conventional transport trolleys and which has extended utility and improved maneuverability. The inventive transport trolley should, in particular, avoid the need for frequent unloading and reloading of transported objects in conventional use.

This object is solved by a transport trolley having the features in accordance with claim 1. The dependent subclaims constitute advantageous embodiments of the invention.

The basic idea of the invention is the providing of a transport trolley, especially for the transporting of piece goods, in which a carrier for accomodating objects is pivotably mounted on a navigable frame. This pivotability means that the carrier can be tilted from a loading state, in which the carrier is aligned to be horizontal or slightly inclined, into a transporting state, in which it is tilted out of the horizontal. A stand wheel cantilever is furthermore pivotably mounted on the frame to jut from said frame and provide a support for the transport trolley when in loading state and which rests against the frame in the transporting state. These measures enable the inventive transport trolley to advantageously provide for both comfort when loading, for example in a supermarket or warehouse, as well as for an easily controlled transporting to another destination or by another vehicle. In the loading state, the transport trolley has, for example, the form of a navigable shopping cart, such as those used in supermarkets. The swiveling into the transporting state, in which the inventive transport trolley takes on the form of a shopping pull-cart or caddie, ensues without any endangering of the objects housed within the carrier.

In accordance with a preferred embodiment of the present invention, the carrier (or: receptacle, transported goods housing) is affixed to at least one platform or frame having front and rear platform supports on its underside coupled to the inward facing side of the frame. In the loading and transporting states, the platform supports form an advantageously stable mounting for the platform and upon a swiveling between the loading and transporting states, provide for a defined path of pivoting which excludes an overturning or unintentional emptying of the carrier.

In accordance with a particularly advantageous embodiment of the inventive transport trolley, the platform supports and the stand wheel cantilever form a synchronal mechanism. The swiveling of the carrier and the positioning up or swinging out of the stand wheel cantilever transpire simultaneously. The front platform supports and the stand wheel cantilever constitute two rigid components coupled to the inward facing side of the frame which, in the loading state, extend out of the frame plane on both sides to support the platform on the one hand and the transport trolley on the other hand and which, in the transporting state, are pivoted into the plane of the frame. This feature renders an improved stability to the transport trolley and facilitates its operation.

In accordance with further important features, the carrier is detachably affixed to the platform. The carrier preferably has a modular construction in order to be able to adapt the transport trolley to a wide variety of tasks when transporting piece goods or performing other transporting tasks. The carrier has at least one rigid floor or side wall to which a control device may be advantageously mounted. Such a control device may comprise, for example, a transponder for identifying the transport trolley, a data memory for recording characteristic data on the piece goods situated in the carrier and/or a display device. Two wheels are provided on the navigable frame for fulfilling the cited pull-cart function when in the transporting state. The wheels are advantageously affixed with ball bearings, whereby travelling comfort is enhanced and small obstacles (e.g. stairs, curbs) are more easily overcome.

In accordance with a particularly preferential aspect of the invention, the transport trolley is to be used when purchasing goods in retail stores. This use will reduce or do away with the above-mentioned unloading and reloading procedures. Goods, particularly food, are treated with gentle care and the purchasing process is expedited.

The invention has the following additional advantages. The inventive transport trolley has low weight when empty. It is readily maneuvered and transported even through tight areas such as, for example, kitchens, basements, garages or other small spaces. Its modular construction, especially to the carrier on the platform, enables a user to realize a custom adaptation of the transport trolley's configuration and function to his or her own particular needs. The inventive transport trolley can be easily loaded into any vehicle or attached to a towing vehicle, for example a bicycle. Hence, the transporting of objects to a destination is simplified.

The inventive transport trolley has a high stability both in the loading state as well as in the vertical orientation to the frame in the transporting state (freestanding caddy). Its high operational safety is of great advantage, particularly due to its use in public areas such as, for example, on busses or trains. Use of the transport trolley is greatly variable, it is easy and simple to operate as well as being comfortable, sturdy, long-lasting and endowed with a high functionality. The transport trolley can feasibly be rigged to transport a child (baby carrier or separate footboard) or used as a bicycle trailer. Safety measures can also be provided such as, for example, lights, reflectors or an anti-theft device.

Special advantages ensue when integrating the transport trolley into new sales strategies such as, for example, SNS (Shopping Navigation System). A display can be provided on the carrier for the wireless transmission from the supermarket to the customer of offers, properties of a product (weight), or other product information. For example, product information could feasibly be enlarged on the display in order to facilitate the shopping process for people with poorer vision.

Further advantages and details of the present invention will become apparent from the description of the enclosed drawings, which show:

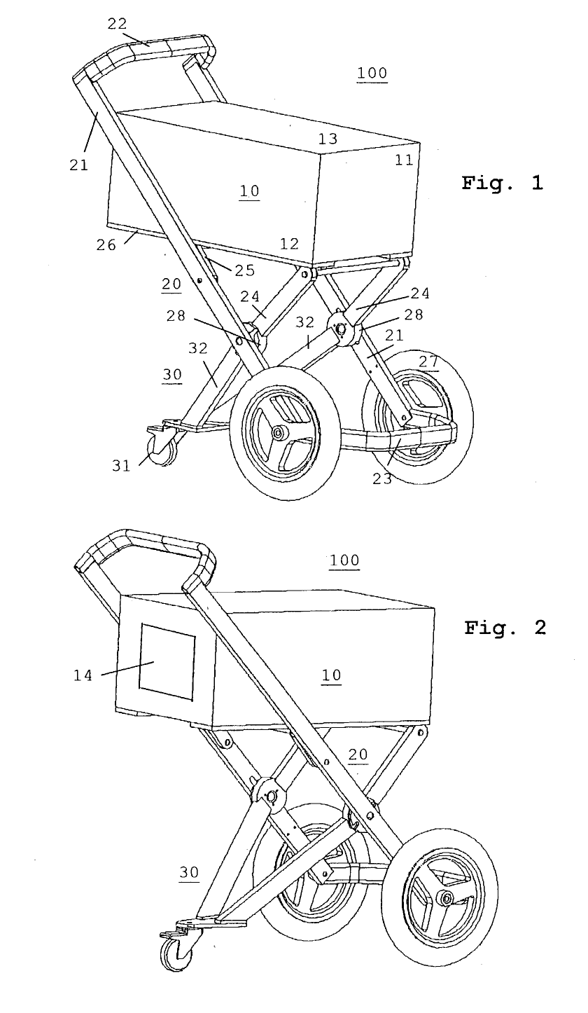

FIGS. 1-3: a first embodiment of the inventive transport trolley in the loading state,

FIG. 4: an illustration on the adjusting of the inventive transport trolley from the loading state to the transporting state,

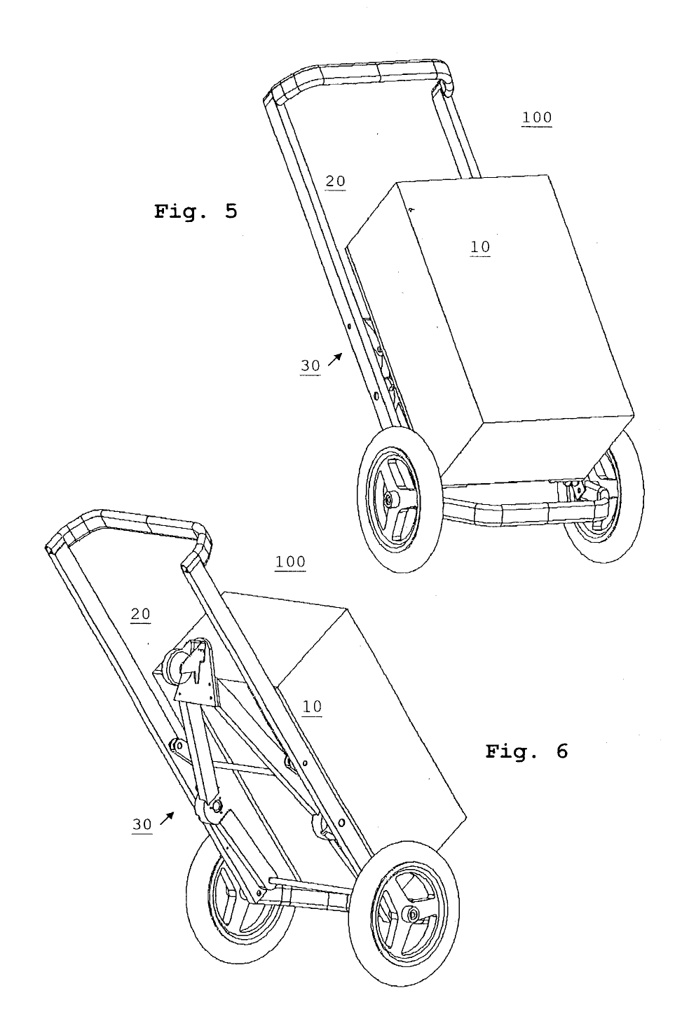

FIGS. 5-7: additional views of the embodiments of the inventive transport trolley in the transporting state as depicted in FIGS. 1-3, and

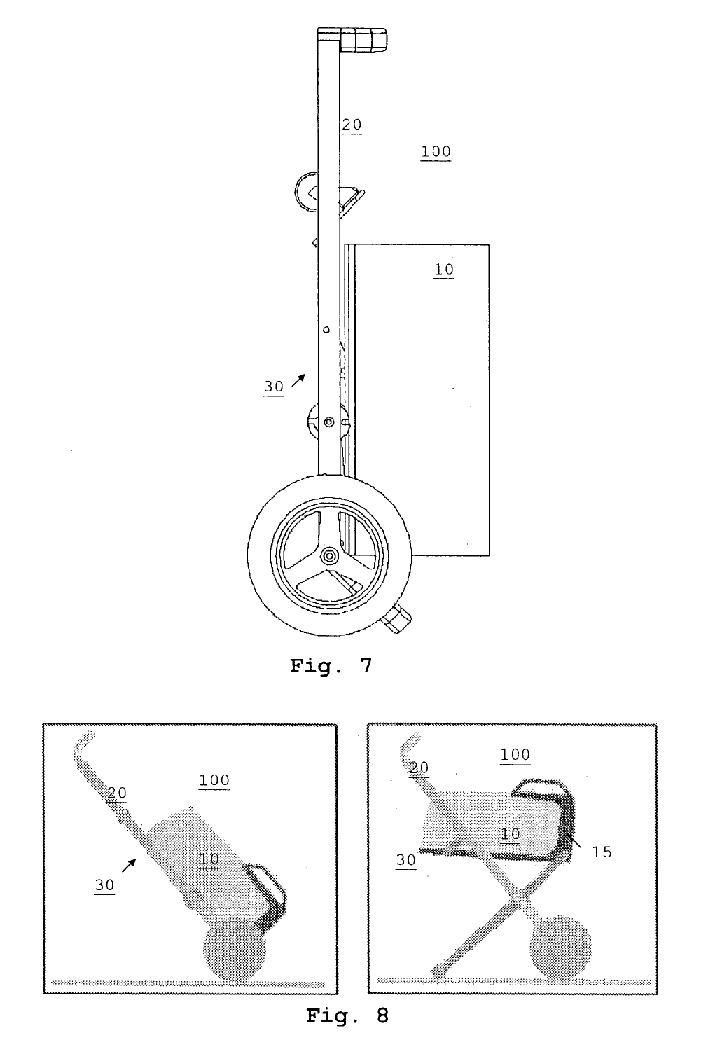

FIG. 8: schematic side views of another embodiment of the inventive transport trolley.

The present invention will be described in the following with an example drawn in reference to the transport trolley's preferential application of shopping for goods. It is to be emphasized, however, that the present invention is not to be restricted to this application, but instead is also applicable in corresponding manner for other applications when transporting piece goods or individual objects such as, for example, the transporting of tools and materials by craftsmen, the transporting of equipment by medical personnel, for transporting files within an office, mobile devices, etc.

FIGS. 1-7 illustrate a first embodiment of the inventive transport trolley showing the transport trolley in various different positions. In accordance with FIG. 1, the transport trolley 100 comprises a carrier 10, a frame 20, and a stand wheel cantilever 30. Carrier 10, representing the receptacle for the goods or objects to be transported, is only illustrated in schematic fashion. Generally speaking, carrier 10 represents a closed or open receptacle, a multi-part receptacle configuration, e.g. for housing goods, or a receptacle module. Carrier 10 may be detachably coupled to the frame.

Carrier 10 may be arranged to be horizontal in the loading state of the transport trolley pursuant to FIG. 1 or, alternatively, with a forward or rearward inclination relative the direction of travel. This slightly inclined orientation (e.g. 5°) can be advantageous for the stable arrangement of transported goods within carrier 10.

The volume of carrier 10 is preferably in a range of between 50 and 100 liters, e.g. approx. 70 liters. The interior of carrier 10 may be subdivided by means of additional pockets, for example for smaller items or frozen goods. A rigid floor section 11 of carrier 10 advantageously forms a pallet-like area, suitable for supporting cases of drinks. The volume of carrier 10, when used merely as a plate-shaped housing (with a peripheral edge, as the need may arise), can correspondingly also amount to less than 50 liters (down to 0 liters).

Carrier 10 may be disposed with an electronic control device 14, as illustrated in FIG. 2 only in schematic fashion. The control device preferably comprises a display, a computer circuit including a memory, and a transponder for the exchange of data between goods in carrier 10 and the supermarket's central sources of information. A card reading device may also be provided for reading a user's debit or credit card. Control device 14 may be mounted as depicted on carrier 10 and/or handle 22. Mounting on handle 22 has the advantage that same forms a protective frame for control device 14.

Frame 20 has a substantially rectangular, plane shape which is formed by two elongated side arms 21, their ends connected above in handle 22 and below (at the base) in front elbow 23 (lower strut). The side arms 21 consist of rod-shaped components. Profile elements such as profiled rails or tubular elements are, for example, provided. The side arms are preferably made from, as are the other mechanical components of the transport trolley, a light metal, a light metal alloy, a plastic or a compound material. Side arms 21 extend parallel to one another, spanning a reference plane (frame plane) which, in the loading state, constitutes a predefined angle to the horizontal base section and, in the transporting state, is tilted relative the horizontal dependent on the user's handle height, and which approximates a vertical orientation in the freestanding position. Handle 22 and front elbow 23 may be disposed to be in the same reference plane as side arms 21 or, as depicted, preferably jutting out from said reference plane. Dependent upon the desired travel comfort and the functionality to transport trolley 100, handle 22 and/or front elbow 23 may also be swivable and lockable with respect to side arms 21. As an example, front elbow 23 can form a support for the freestanding transport trolley 100 (see FIG. 7). In accordance with a modified embodiment of the inventive transport trolley, front elbow 23 can be omitted, replaced instead with an axle between the wheels.

Front (24) and rear (25) platform supports are provided on the inward facing sides of side arms 21, to which at least one platform or frame is affixed. In the example embodiment as depicted, two lateral elongated platforms 26 are mounted in a manner of carrier tracks on which carrier 10 rests, one between the left front and rear platform supports and one between the right front and rear platform supports. Alternatively, a common platform may also be provided as an integral component. The ends of platform supports 24, 25 are coupled to the bottom or sides of platform 26.

A front wheel 27 is affixed to each lower (base side) end of side arms 21, said front wheels 27 preferably resting on ball bearings in order to facilitate the motion of transport trolley 100.

Rear platform supports 25 form a second point of support for platform 26 on both respective sides. Rear platform supports 25 are likewise coupled to the inward facing sides of side arms 21 and swivable from an upward orientation toward handle 22 in the loading state into a downward orientation toward front elbow 23 in the transporting state.

Stand wheel cantilever 30 is arranged at the rear or underside of frame 20. It comprises a caster-fitted supporting stand or rear wheel 31, preferably rotatable in all directions, which is affixed to frame 20 by means of two struts 32. Struts 32 are coupled to the inward facing sides of side arms 21 so that stand wheel cantilever 30 can be pivoted from an extended supporting position relative frame 20 into a retracted position. When in the latter, stand wheel cantilever 30 rests flush against frame 20 and is aligned essentially parallel to the frame plane. Since stand wheel 31 is arranged centrally relative the direction of travel of transport trolley 100, struts 32 take on a V-shaped, diverging form.

The arrangement of struts 32 and front platform supports 24 on side arms 21 is provided with two swivel plates 28, which are rotatably affixed to said side arms 21. One respective front platform support 24 and strut 32 form, together with the associated swivel plate 28, a rigid component such that upon turning swivel plate 28, stand wheel cantilever 30 simultaneously moves from the supporting position to the retracted position and carrier 10 moves from the transport trolley's loading state to its transporting state.

According to a modified embodiment, however, an independent pivoting to carrier 10 on the one hand and stand wheel cantilever 30 on the other may also be provided. The swivel plates can furthermore be omitted, provided the platform supports and struts respectively form a continuous, angled component. Moreover, as an alternative to stand wheel 31, two stand wheels may also be provided, wherein the angled orientation to struts 32 can then be, as circumstances dictate, eliminated.

FIGS. 1-3 illustrate the loading state of transport trolley 100 having a horizontally-aligned carrier 10 and an extended stand wheel cantilever 30. In this position, the transport trolley can be, for example, navigated through a supermarket for the purpose of putting items taken from shelves into carrier 10. Carrier 10 constitutes, for example, a basket or a box having a rigid floor wall 11, rigid or at least partially flexible side walls 12, and a rigid or flexible lid 13. Lid 13 may be opened (removed, fastened back, raised, etc.) for loading. According to a particular advantage of the invention, loading of carrier 10 ensues in a manner which is as gentle as possible on the goods, for example by bottles being arranged in the front section of carrier 10 and fragile goods being arranged in its rear section. Heavy goods are then advantageously situated in stable manner over the chassis (wheels 27, 31) in the loading state, and as low as possible to the ground when in the transporting state (see FIGS. 5 and 6).

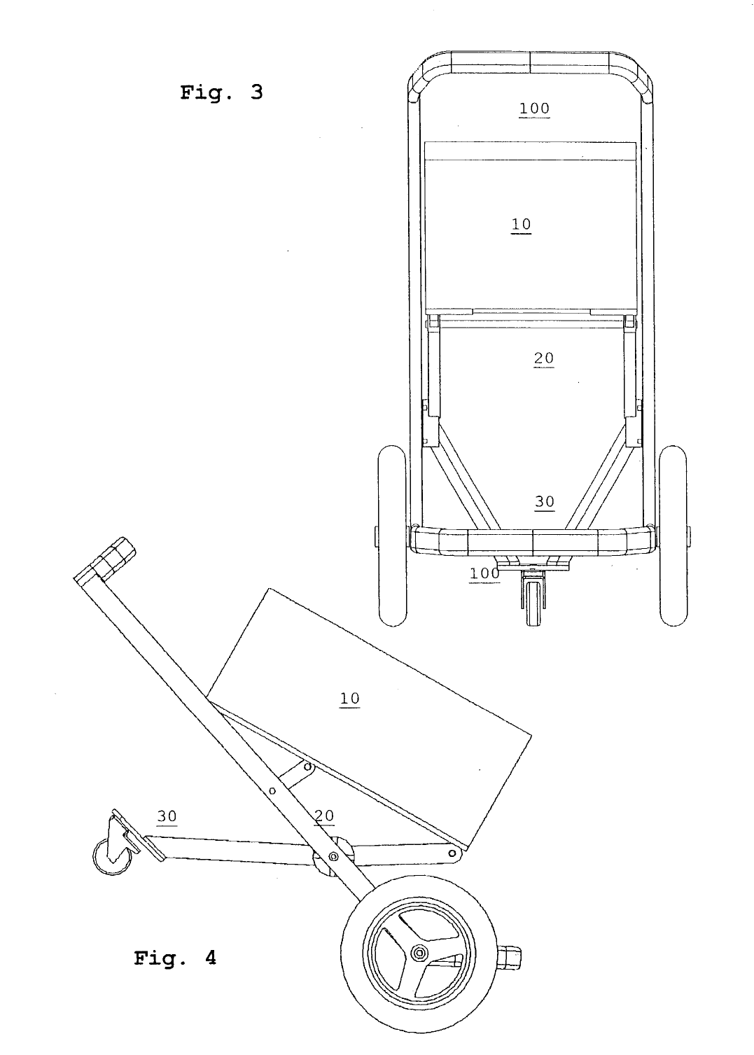

FIG. 3 shows a frontal view of the inventive transport trolley 100 in the loading state. It can be seen that carrier 10, platforms 26, platform supports 23, 24 and struts 32 are arranged within frame 20. Swivel plates 28 enable a spacing to be set between the components relative the inward facing sides of side arms 21, so that any unintentional pinching of the user can be avoided.

FIG. 4 illustrates an intermediate state during the transport trolley's transition from loading state to transporting state. Subsequent release of a lock, carrier 10 is pivoted downward. This can ensue by pulling on stand wheel cantilever 30, by means of a rope or cable, or by a simple displacing the center of gravity. Carrier 10 moves from a stable horizontal position into another stable tilted position. In the transporting state, a locking of platform supports 24, 25 and/or struts 32 is rendered on the frame, for example utilizing pushbuttons or spring-mounted bolts.

In accordance with a preferred embodiment of the present invention, the transition from loading state to transporting state is triggered manually by a control device (pushbutton) mounted on handle 22. Swivel plates 28 are formed by swivel joints each comprising inner sliders and a sliding block. Pressing the pushbutton results in a cable releasing the slider so that carrier 10 can be taken past a dead spot into the transporting state.

The transporting state of inventive transport trolley 100 is illustrated in FIGS. 5 and 6. Carrier 10 has been pivoted into a position out of the horizontal. Platforms 26 extend essentially parallel to the frame plane. The tilting of front platform supports 23 up into the frame plane results in struts 32 with stand wheel 31 simultaneously being brought into the retracted position. In this position, transport trolley 100 can be grasped in the manner of a conventional caddy by handle 22 and pulled to its destination or put into use as a bicycle trailer.

To employ transport trolley 100 as a bicycle trailer, same is equipped with a coupling means (not shown). Said coupling means can be mounted to the upper handle (22; see FIG. 1) or, preferably, to stand wheel cantilever 30. In the latter case, stand wheel 31 is pivotable upward relative struts 32, whereby the coupling means for receiving a bicycle drawbar is affixed to the plate which also supports stand wheel 31. Alternatively, struts 32 can themselves be pivotable so that given a horizontal orientation to carrier 10, stand wheel 31 along with a lower section of struts 32 can be pivoted away from the ground. In this case as well, the coupling means is preferably affixed to the plate which also supports stand wheel 31.

A vertical alignment pursuant to FIG. 7 is alternatively feasible, whereby the front elbow 23 serves as support. Said front elbow 23 protrudes far enough from the frame plane that no tipping torque is generated when carrier 10 is loaded and in the upright stationary position, the effect of which would be the toppling of the cart.

FIG. 8 schematically illustrates a further embodiment of inventive transport trolley 100 in the transporting state (left image segment) and in loading state (right image segment). In this configuration, carrier 10 is affixed directly to the ends of rear and front platform supports 24, 25 without any additional platforms being provided. Carrier 10 moreover consists of a rigid shell 15 on which the platform supports are affixed and which assumes the function of the floor section 11 described above, as well as a flexible bag 16 which can be opened at the top or on the side. The image on the left in FIG. 8 shows, analogously to FIG. 7, that in the retracted position, the stand wheel cantilever is advantageously almost completely masked by frame 20 such that, in the transporting state, the transport trolley exhibits an outer appearance corresponding to that of a caddy and, as with conventional pull-carts, can be readily stowed into or secured to other vehicles.

To secure the transport trolley, additional retaining means such as, for example, belt grommets, magnetic fasteners or straps can be provided on frame 20. Such retaining means would then allow the transport trolley to be secured in, for example, an automobile or on public transportation.

The features of the invention disclosed in the preceding description, the drawings and the claims may be significant, individually as well as in any arbitrary combination, to the realization of the invention in its various configurations.

1. A transport trolley, especially for the transporting of piece goods, having a carrier (10), which forms a receptacle for said piece goods, affixed to a navigable frame and pivotable from a loading state, in which said carrier is arranged with an essentially horizontal alignment, into a transporting state in which said carrier is arranged to be tilted out of the horizontal, wherein said frame is provided with a stand wheel cantilever which juts out from said frame in the transport trolley loading state and forms a support, and which rests against frame in the transport trolley transporting state.

2. The transport trolley according to claim 1 in which said carrier is mounted to at least one platform having pivotable front and rear platform supports on its underside articulated to the inward facing side of said frame.

3. The transport trolley according to claim 2 in which said platform supports and said stand wheel cantilever form a synchronal mechanism with which carrier and stand wheel cantilever are pivotable simultaneously.

4. The transport trolley in accordance with claim 1 in which said carrier has a rigid floor section at its lower end in the transporting state.

5. The transport trolley in accordance with claim 1 in which said carrier is detachable from said transport trolley as a receptacle module.

6. The transport trolley in accordance with claim 1 in which said carrier or a handle of said transport trolley is provided with a control device comprising a display device and a data processing device.

7. The transport trolley in accordance with claim 1 in which retaining means are provided on said frame for the releasable securing of said transport trolley within the interior of a vehicle or on public transportation.

8. The transport trolley in accordance with claim 1 in which wheels are affixed to frame using ball bearings.

9. The transport trolley in accordance with claim 1 in which a coupling means for a bicycle drawbar is provided on stand wheel cantilever or on handle.

10. Method of using a transport trolley in accordance with claim 1 for shopping for goods in retail stores or as a bicycle trailer.
